(19) United States
(12) Patent Application Publication
(10) Pub. No.: US 2009/0105927 A1
(43) Pub. Date: Apr. 23, 2009

(54) Control system for automotive vehicle having diagnosis function

(75) Inventor: Hidenori Arai, Kariya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/284,866

(22) Filed: Sep. 25, 2008

(30) Foreign Application Priority Data
Sep. 26, 2007 (JP) 2007-249464

(51) Int. Cl. F02D 45/00

(52) U.S. Cl. 701/102; 701/36

(57) ABSTRACT

A system for controlling on-board air-conditioner according to the present invention includes input/output means such as sensors and driving motors, a control means such as a microcomputer, and input/output circuits connecting the input/output means to the control means. Means for generating diagnosis information, such as failure flag-setting circuits, feedback circuits and current sensors detecting sensor signals, are included in the input/output circuits. Upon receiving a request for diagnosis from an outside diagnosis device, diagnosis data including positions and nature of the failures occurred in the control system are outputted, taking into consideration the diagnosis information generated and stored in the control means. The diagnosis data may be displayed on a display panel of the outside diagnosis device. The diagnosis information generating means may be simply added to existing input/output circuits to thereby constitute cost-effectively the control system having a diagnosis function.

### CROSS-REFERENCE TO RELATED APPLICATION

This application is based upon and claims benefit of priority of Japanese Patent Application No. 2007-249464 filed on Sep. 26, 2007, the content of which is incorporated herein by reference.

### BACKGROUND OF THE INVENTION

1. Field of the Invention

The present invention relates to a control system for an automotive vehicle, which is able to output diagnosis data for the own system according to a request for diagnosis from an off-board device.

2. Description of Related Art

An example of a control system (an air-bag control system) having a diagnosis function is disclosed in JP-A-2005-63054. The air-bag control system includes an application specific integrated circuit (ASIC) that performs diagnosis of functions necessary for the air-bag control. The diagnosis is performed at a predetermined interval or according to a trigger from outside factors. A microcomputer determines whether a failure or failures occurred in the ASIC based on the diagnosis data obtained from the ASIC. The functions necessary for controlling the air-bag are performed in plural circuit blocks divided in the ASIC. Diagnosis results for plural circuit blocks are inputted to the microcomputer as serial data, and the microcomputer specifies a particular circuit block where a failure occurred based on a bit position showing the failure in the serial data. However, this system includes a problem that a particular position in the circuit block having a failure cannot be specified although the circuit block including a failure is specified.

### SUMMARY OF THE INVENTION

The present invention has been made in view of the above-mentioned problem, and an object of the present invention is to provide an improved on-board control system in which a failed position is specified by its own diagnosis.

The present invention is advantageously applied to a control system for an air-conditioner mounted on an automotive vehicle. The control system includes various sensors, such as temperature sensors and pressure sensors, and various drivers such as blower motors (correctively referred to as input/output means). The control system also includes control means composed of a microcomputer. The input/output means are connected to the control means via respective input/output circuits. Flag-setting circuits for setting flags indicating failures in the input/output means or circuits, feedback circuits for detecting driving current, and current sensors for detecting signal current from the sensors are provided in the respective input/output circuits (correctively referred to as means for generating diagnosis information).

In a process of diagnosing the control system, a request for diagnosis is sent from an outside diagnosis device located at a car dealer or a repair shop to the microcomputer of the control system. If a diagnosis for the air-conditioner control system is requested, diagnosis data indicating positions and kinds of failures are outputted and displayed on the display panel of the outside diagnosis device. The diagnosis data are outputted, taking into consideration the diagnosis information generated in the means for generating diagnosis information.

According to the present invention, positions and kinds of failures in the control system are easily and quickly detected. The means for generating diagnosis information may be simply added to existing circuits to manufacture the control system including the diagnosis function cost-effectively. Other objects and features of the present invention will become more readily apparent from a better understanding of the preferred embodiment described below with reference to the following drawings.

### BRIEF DESCRIPTION OF THE DRAWINGS

FIG. 1A is a block diagram showing an entire system for controlling an air-conditioner mounted on an automotive vehicle;

FIG. 1B is a perspective view showing positions of a face duct, a defroster duct and a foot duct of the air-conditioner in a passenger compartment;

FIG. 2 is a block diagram showing an air-conditioner ECU (Electronic Control Unit);

FIG. 3 is a flowchart showing a process of outputting diagnosis data; and

FIGS. 4-8 are displays shown on a display panel of an off-board diagnosis device connected to the on-board air-conditioner ECU.

### DETAILED DESCRIPTION OF THE PREFERRED EMBODIMENT

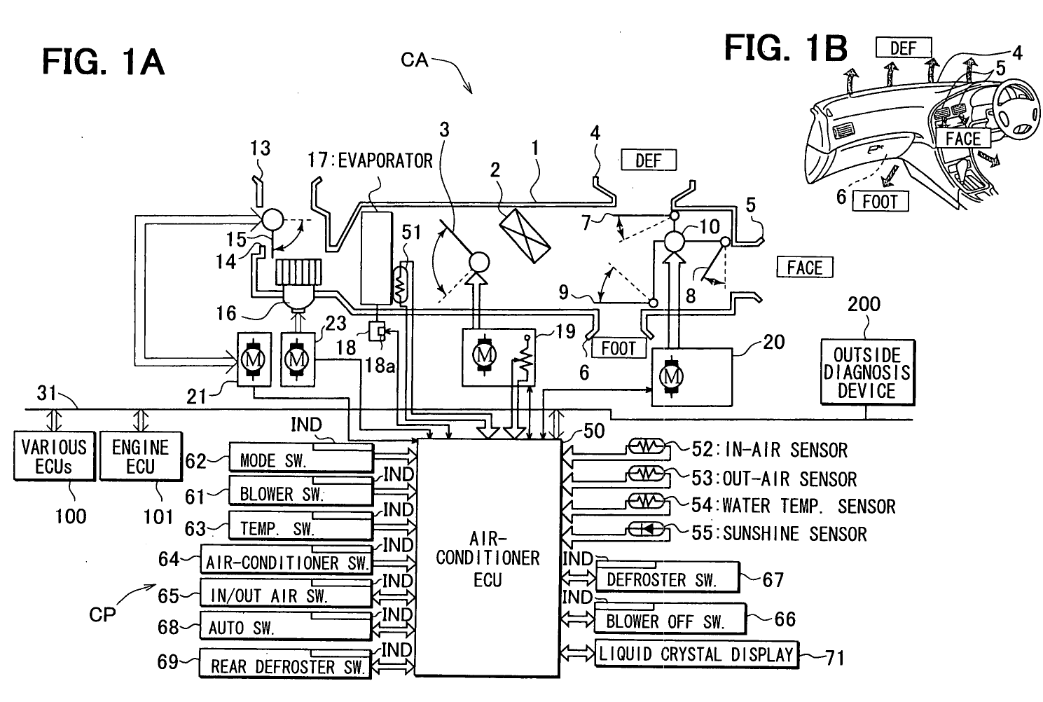

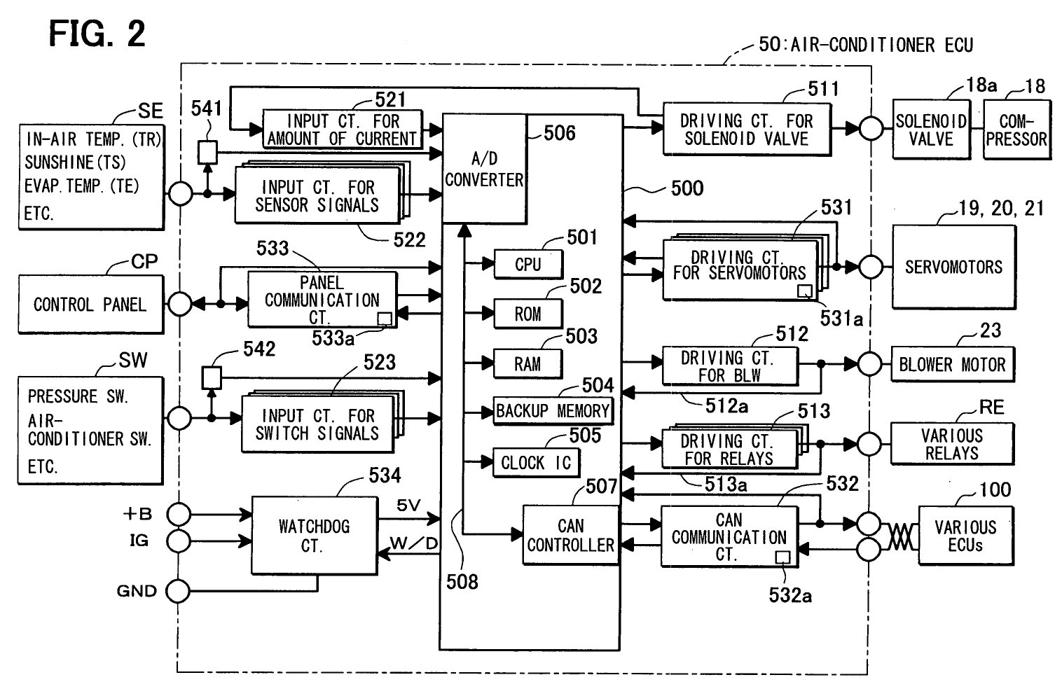

A preferred embodiment of the present invention will be described with reference to accompanying drawings. FIGS. 1A and 1B show an entire structure of an air-conditioner system CA (as a representative control system for an automotive vehicle) to which the present invention is applied. The air-conditioner CA includes a duct 1 that has an inlet port 13 for introducing in-air (air in a passenger compartment) and an inlet port 14 for introducing out-air (outside air). Introduction of the in-air and the out-air is switched by an in/out switching damper 15, and the in-air or the out-air is introduced into the duct 1 by a blower 16 driven by a blower motor 23.

In the duct 1, an evaporator 17 for cooling the introduced air and a heater core 2 for heating the air are disposed. An amount of heated air and the cooled air is controlled by an air-mix damper 3. Angular positions of the air-mix damper 3 are controlled by a servomotor 19. The heated air and the cooled air mixed with the air-mix damper 3 are blown out from a defroster duct (DEF) 4, a face duct (FACE) 5 and/or a foot duct (FOOT) 6. The defroster duct 4 is open at a bottom portion of a windshield, the face duct 5 is open at a center portion of an instrument panel toward a driver, and the foot duct 6 is open at a bottom portion of the instrument panel toward feet of the driver. Opening degrees of these ducts 4, 5, 6 are controlled by respective dampers 7, 8 and 9. These dampers 7, 8, and 9 are controlled by a damper gear device 10 that is driven by a servomotor 20. Three dampers 7, 8, 9 are controlled to any one of the following states: where only one of the three dampers are open; any combinations of two dampers are open; or all the dampers are open.

The in/out switching damper 15 is driven by the servomotor 21, the dampers 7, 8, 9 are driven by the servomotor 20, and the blower 16 is driven by a blower motor 23. The blower motor 23 is composed of, e.g., a brushless motor which is controlled under a PWM (Pulse Width Modulation) control. All the motors 19, 20, 21 and 23 are controlled by an air-conditioner ECU 50 which will be described later in detail.

Refrigerant compressed by a variable capacity compressor 18 is supplied to the evaporator 17. The variable capacity compressor 18 is a known type or a compressor having a swash plate. An inclination angle of the swash plate is controlled by a solenoid valve 18a which is driven under control of the air-conditioner ECU 50. The solenoid valve 18a, the motors 19, 20, 21 and 23 function as output means together with various relays RE described later.

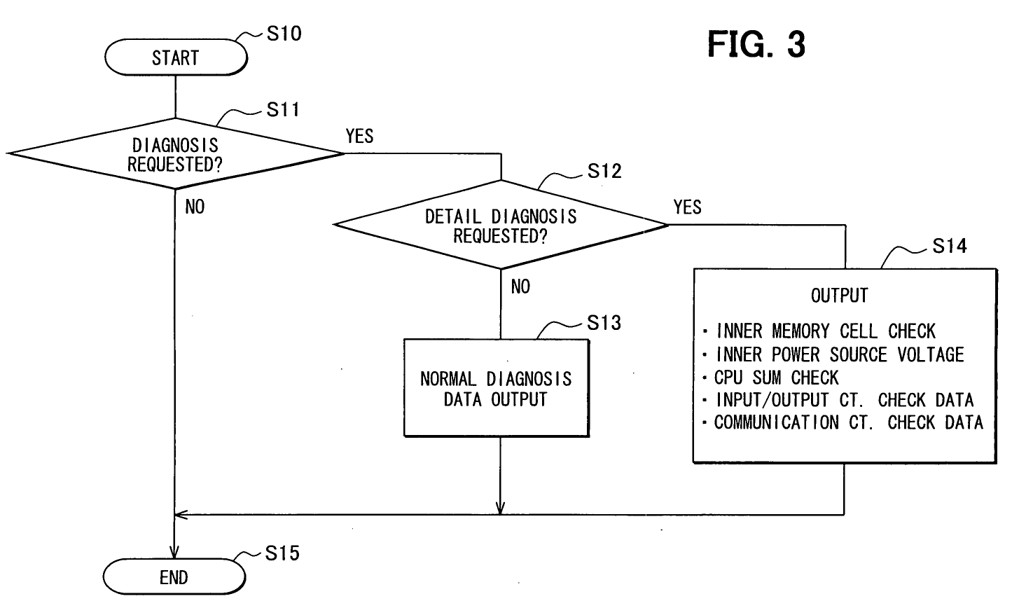

As shown in FIG. 2, the air-conditioner ECU 50 is mainly composed of CPU 501, ROM 502, RAM 503, a backup memory 504, a clock IC 505, an A/D converter 506, a CAN controller 507, an internal bus line 508 connecting these components. The CPU 501 outputs control signals to output circuits described below according to operation of an air-conditioner control farm ware (not shown) stored in the ROM 502. The RAM 503 temporarily memorizes various sensor signals, switch signals, driving signals, communication data and diagnosis codes obtained by the CPU 501. The RAM 503 also functions as a work memory that is used in operating programs. The backup memory 504 is able to memorize and maintain the diagnosis codes and freeze frame data even when the air-conditioner CA are not in operation or when the air-conditioner ECU 50 is shut down. The backup memory 504 is composed of an EEPROM (Electrically Erasable & Programmable Read Only Memory) or a flash memory. Date and clock information from the various sensor signals, the switch signals, the driving signals, the communication data and the clock IC50 are sequentially written separately or as a whole in predetermined memory regions.

The A/D converter 506 is composed of a known A/D converter circuit. The A/D converter 506 converts analog data showing an amount of current or voltage fed from input circuit described below to digital data which are able to be processed in the CPU 501. The clock IC 505 that is also named as a real time clock IC sets a calendar and time according to request from the CPU 501 and sends those data to the CPU 501 if necessary. The CAN controller 507 is an interface for communicating with the engine ECU 101 and various ECUs 100 (refer to FIG. 1). The CAN controller 507 outputs communication data to the CAN bus 31 that functions as a multiplex communication bus via a CAN communication circuit 532 that converts communication levels and performs transmission controls.

The air-conditioner ECU 50 includes, as output circuits, a driving circuit 511 for the solenoid valve 18a, a driving circuit 512 for the blower motor 23 and a driving circuit 513 for various relays RE (such as a relay for holding an amount of air blown from the blower 16 at a H-level or an L-level) as output circuits. The air-conditioner ECU 50 also includes, as input circuits, an input circuit 521 for detecting a mount of current flowing through the solenoid valve driving circuit 511, an input circuit 522 for inputting the sensor signals from various sensors SE and an input circuit 523 for inputting signals from the various switches SW. The air-conditioner ECU 50 further includes, as input and output circuits, a communication circuit 531 for the servomotors for converting signal levels, the CAN communication circuit 532 mentioned above, a panel communication circuit 533 and a watchdog circuit 534 for detecting voltage supplied to the microcomputer 500.

The communication circuit 531 for the servomotors, the CAN communication circuit 532 and the panel communication circuit 533 are composed of integrated circuits. These circuits 531, 532, 533 include respective flag-setting circuits 531a, 532a and 533a, each of which sets a fail-flag to “0” when communication is normally performed and to “1” when communication is abnormal. The flags set by the flag-setting circuits 531a, 532a, 533a are memorized in the RAM 503.

An amount of current supplied to the solenoid valve 18a from the solenoid valve driving circuit 511 is inputted to the microcomputer 500 through the current input circuit (means for generating diagnosis information) 521 and is memorized in the RAM 503. An amount of current supplied to the blower motor 23 from the blower motor driving circuit 512 and an amount of current supplied to various relays RE from the relay driving circuit 513 are inputted through respective feedback circuits (means for generating diagnosis information) 512a, 513a to the microcomputer 500 and memorized in the RAM 503. The watchdog circuit 534 detects, according to an order from the CPU 501, a level of voltage supplied to the microcomputer 500 from a battery, and the detected voltage is memorized in the RAM 503.

Various sensors SE functioning as input means are connected to the air-conditioner ECU 50. The various sensors SE include an evaporator temperature sensor 51 that detects air temperature TE at an immediate downstream portion of the evaporator 17, an in-air temperature sensor 52 that detects temperature TR in an passenger compartment, an out-air temperature sensor 53 that detects outside air temperature TAM, an water temperature sensor 54 that detects temperature of engine cooling water TW, and a sunshine sensor 55 that detects an amount of sunshine TS. The sensor signals from the various sensors are inputted to the microcomputer 500 through an input circuit 522 for the sensor signals. An amount of sensor current corresponding to each sensor signal is detected by a current sensor 541 and directly inputted to the microcomputer without passing through the input circuit 522 for sensor signals.

A control panel CP functioning as an input/output means is connected to the air-conditioner ECU 50. The control panel CP is communicably connected to the microcomputer 500 through a panel communication circuit 533. Switches listed below are installed in the control panel CP together with indicator lamps IND that are lit in response to operation of the respective switches: a blower switch 61 for setting an amount of air blown out of the blower 16, a mode switch 62 for setting modes of blown air, a temperature switch 63 for setting temperature in the passenger compartment, an air-conditioner switch 64 for operating the variable capacity compressor 18, an in/out air switch 65 for setting an in-air mode or an out-air mode, a blower off switch 66 for turning off the blower 16, a defroster switch 67 for operating a defroster, an auto switch 68 for automatically operating the blower motor 23 and the variable capacity compressor 18, and a rear defroster switch 69 for operating a rear defogger (not shown). A liquid crystal display panel 71 that displays various information regarding operation of the air-conditioner, such as set temperature, blowing modes, an output level of the blower 16 and a clock, is installed in the control panel CP.

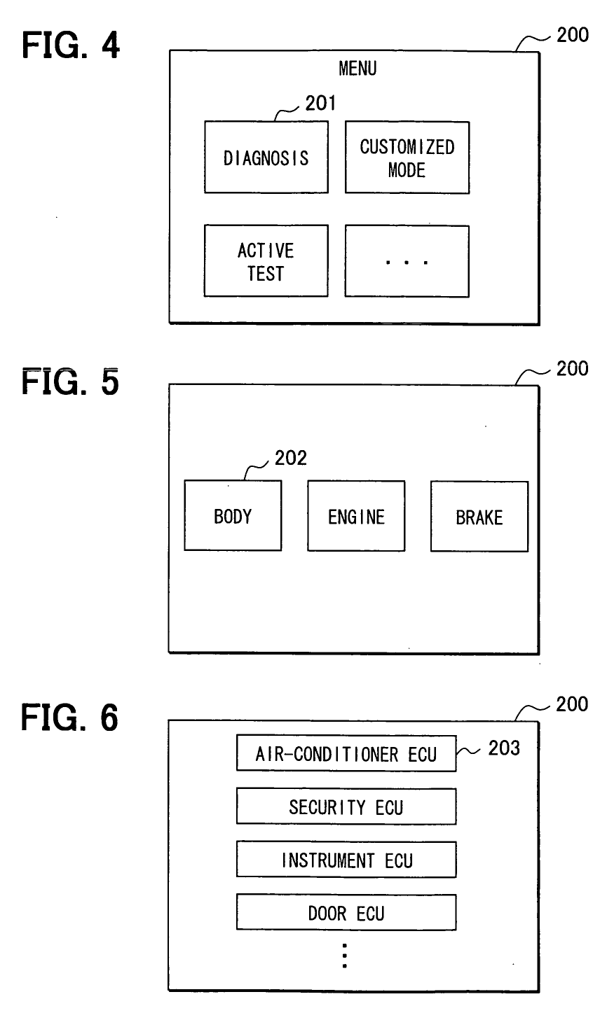

The CPU 501 in the air-conditioner ECU 50 performs various control programs for controlling the air-conditioner according to operation of switches in the control panel CP. The CPU 501 also performs a program, shown in FIG. 3, for diagnosing the operation of the control system of the air-conditioner. The diagnosis program shown in FIG. 3 is started at step S10, when an outside diagnosis device 200 (shown in FIG. 1A) is connected to the CAN bus 31 through a predetermined connector and an ignition switch of a vehicle is turned on. The outside diagnosis device 200 is located at a car dealer or a repair shop, for example.

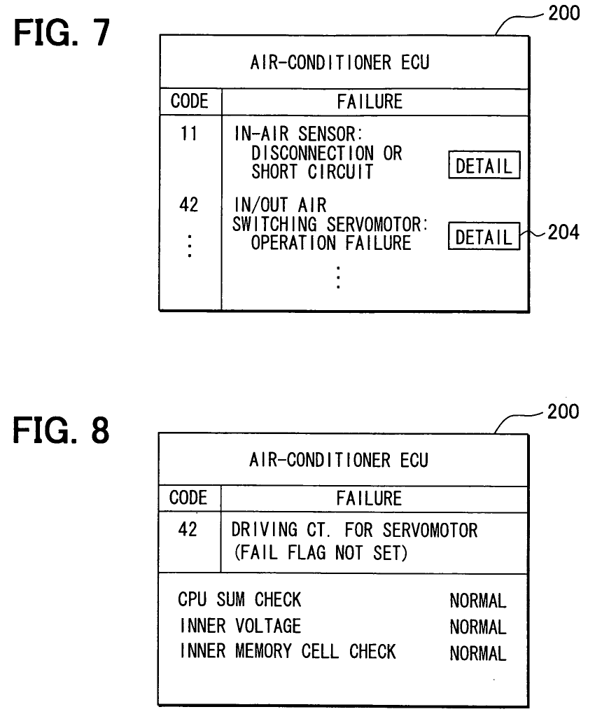

The outside diagnosis device 200 includes a display panel which is operable by touching (a touch panel). An example of a diagnosis process will be explained below. A menu including various diagnosing courses is displayed on the touch panel as shown in FIG. 4. Upon touching “diagnosis” 201 in the menu, a display shown in FIG. 5 appears on the touch panel. Upon touching “body” 202 on the display, a list of various ECUs concerning “body” is displayed as shown in FIG. 6. When “air-conditioner ECU” is touched, the CPU 501 determines that a diagnosis of the air-conditioner ECU is requested. This step corresponds to step S11 in a flowchart shown in FIG. 3. Then, at step S12, whether a detailed diagnosis is requested or not is determined.

If the detailed diagnosis is not requested, i.e., only a standard diagnosis is requested, the process proceeds to step S13, where results of the air-conditioner ECU diagnosis are displayed on the display panel based on the data stored in memories such as the ROM 503. An example of the diagnosis results is shown in FIG. 7. In this example, it is shown that the in-air sensor 52 failed together with a failure code 11. This failure is determined from the fact that the output signal of the in-air sensor 52 inputted through the input circuit 522 is 0 volt or five volts, representing a disconnection or a short circuit in the in-air sensor 52. In this example, it is also shown that the servomotor 21 for switching the in-air and the out-air failed together with a corresponding code 42. The failure of operation of the servomotor 21 is determined from the fact that communication from the communication circuit 531 to the servomotor 21 is in failure because a fail-flag is set to “1” or the fail-flag is not set.

If “detail” 204 shown in FIG. 7 is touched, it is determined that the detailed diagnosis is requested at step S12 (FIG. 3), and the process proceeds to step S14. At step S14, the detailed diagnosis for the servomotor 21 is performed as shown in FIG. 3. Then, the results of the detailed diagnosis are displayed on the panel as shown in FIG. 8. For example, the CPU 501 determines that the servomotor communication circuit 531 is in failure if the fail-flag therefrom is not set yet. This result is displayed together with the code 42. In addition, results of a sum check of the CPU 501, an inner voltage detected by the watchdog circuit 534, and a cell check of the RAM 503 and the backup memory 504 are displayed. Thus, positions and types of failures occurred are easily known.

The CPU 501 determines that the servomotor communication circuit 531 itself is normal but the servomotor 21 is in failure if the fail-flag from the servomotor communication circuit is set to “1”. This determination of the CPU 501 is shown on the display panel. When the “detail” for the in-air sensor shown in FIG. 7 is touched in the case where a voltage from the input circuit 522 to which the in-air sensor 52 is connected is zero volt or 5 volts, the CPU 501 determines that the input circuit 522 to which the in-air sensor 52 is connected is in failure if an amount of current detected by the input circuit 541 corresponding to the in-air sensor 52 is within a predetermined range. On the other hand, it is determined that the in-air sensor 52 is in failure if the amount of current detected is not within the predetermined range. The results of these determination is displayed on the display panel. Failures in the sensors other than the in-air sensor 52 are determined in the same manner as in the in-air sensor 52.

The CPU 501 determines disconnection or a short circuit in the solenoid valve driving circuit 511 based on the amount of current inputted from the input circuit 521. When it is determined that the solenoid valve driving circuit 511 is in failure due to disconnection or a short circuit, it is displayed on the display panel at step S13 (FIG. 3) that operation of the variable capacity compressor 18 is abnormal. If the detailed diagnosis is requested at step S12, it is displayed that the solenoid valve driving circuit 511 is disconnected or short-circuited together with a code showing the variable capacity compressor 18 at step S14. The failures in the blower motor driving circuit 512 and the relay driving circuit 513 are displayed in the same manner as in the failure in the solenoid valve driving circuit 511.

As understood from the above-explanation, the diagnosis information concerting failures in the servomotor communication circuit 531, the CAN communication circuit 532 and the panel communication circuit 533 is detected by the respective flag-setting circuits 531a, 532a and 533a. The diagnosis information concerting failures in the solenoid valve driving circuit 511 is detected by the current input circuit 521. The diagnosis information concerting failures in the blower motor driving circuit 512 and the relay driving circuit 513 is detected by the respective feedback circuits 512a and 513a. The diagnosis information concerting failures in the various sensors SE and the various switches SW is detected by the respective current sensors 541 and 542. The CPU 501 of the air-conditioner CPU 50 outputs diagnosis data for specified input/output circuits (step S14), according to the diagnosis request (step S12) from the outside diagnosis device 200, taking into consideration the fail-flags and amount of current detected.

Thus, positions of failure in the servomotors 19-21 and the various sensors SE as input/output means, and positions of failure in the communication circuits 531-533 and the driving circuits 511-513 as input/output circuits can be quickly detected. Accordingly, the failure analysis is quickly performed.

In the foregoing embodiment, the flag-setting circuits 531a, 532a and 533a are added to the existing servomotor communication circuit 531, the CAN communication circuit 532 and the panel communication circuit 533, respectively. The feedback circuits 512a and 513a are added to the existing blower motor driving circuit 531 and the relay driving circuit 513, respectively. The current sensor 541 is added to each existing sensor SE, and the current sensor 542 is added to each existing switch SW. Therefore, the diagnosis data can be obtained in a simple structure.

In the foregoing embodiment, the flag-setting circuits 531a, 532a and 533a are provided in the servomotor communication circuit 531, the CAN communication circuit 532 and the panel communication circuit 533, respectively. In place of or in addition to those flag-setting circuits, it is possible to judge failures in the communication circuits 531, 532, 533 in the following manner. Communication data, which are sent from the servomotor communication circuit 531 to servomotors 19-21, from the CAN communication circuit 532 to the various ECUs 100 including the engine ECU 101, and from the panel communication circuit 533 to the control panel CP, are fed back to the air-conditioner ECU 50. The fed back data are compared with the data sent from the CPU 501 to the communication circuits 531, 532 and 533, and it is determined that the communication circuit is in failure if the fed-back data are different from the communication data sent from the CPU 501.

Though the present invention is applied to the system for controlling the automotive air-conditioner in the foregoing embodiment, it may be applied to systems having other ECUs 100.

While the present invention has been shown and described with reference to the foregoing preferred embodiment, it will be apparent to those skilled in the art that changes in form and detail may be made therein without departing from the scope of the invention as defined in the appended claims.

What is claimed is:

1. A control system for an automotive vehicle, comprising:
a control means for controlling an operational function of the automotive vehicle; and
a plurality of input/output means, each connected to the control means via an input/output circuit corresponding to each input/output means, wherein:
each input/output circuit includes means for generating diagnosis information concerning the corresponding input/output means and the input/output circuit; and
the control means outputs diagnosis data for each input/output means and each input/output circuit, taking into consideration the diagnosis information generated in the generating means, according to a request for diagnosis from an outside diagnosis device.

2. The control system as in claim 1, wherein the diagnosis information is a fail-flag set in the input/output means or the input/output circuits, or an amount of current corresponding to an output signal from the input/output means or the input/output circuits.

3. The control system as in claim 1, wherein the control means outputs information indicating its own conditions including a power source voltage together with the diagnosis data.

4. The control system as in claim 1, wherein the control means is means for controlling air-conditioner mounted on the automotive vehicle.
